(19) United States
(12) Patent Application Publication
(10) Pub. No.: US 2017/0355068 A1
(43) Pub. Date: Dec. 14, 2017

(54) SCREW REMOVER TOOL DEVICE AND METHOD

(71) Applicant: Dennis Lacovara, Philadelphia, PA (US)

(72) Inventor: Dennis Lacovara, Philadelphia, PA (US)

(21) Appl. No.: 15/618,036

(22) Filed: Jun. 8, 2017

Related U.S. Application Data
(60) Provisional application No. 62/347,231, filed on Jun. 8, 2016.

(51) Int. Cl. B25B 27/18; B25B 13/06

(52) U.S. Cl. CPC B25B 27/18; B25B 13/065

(57) ABSTRACT

A screw removal tool includes an extension shaft configured to be insertable into a universal screwdriver for torquing use and a body configured to couple to and remove a damaged screw via engagement of said damaged screw with an internally toothed extraction fitment configured to engage a peripheral surface of a screw head of a damaged screw such that a grip-friction is impartable upon said screw head.

### CROSS-REFERENCE TO RELATED APPLICATION(S)

The present application is related to and claims priority to U.S. Provisional Patent Application No. 62/347,231 filed Jun. 8, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of hand tools of existing art and more specifically relates to a screw removal tool.

### RELATED ART

Fasteners are often used to couple objects together. There are many types of fasteners available. Currently, it's nearly impossible to remove screws without a Phillips head or slotted screwdriver and appropriately sized bits. Additionally, the screw head may be rusted, worn out, and the screw may be stripped, making it extremely difficult and frustrating to grip. Further, some people may not be able to exert enough force to remove screws on their own. A suitable solution is desired.

U.S. Pat. No. 5,737,981 to David Lewis Hildebrand relates to a removal device for threaded connecting devices. The described removal device for threaded connecting devices includes a removal device adapted for the removal of difficult to remove threaded connecting devices threaded in a first direction. The device includes a body having a first end and a second end, wherein the first end includes an opening which extends toward the second end of the body. The opening is sized to receive a threaded connecting device threaded in a first direction and continuously tapers from a first diameter at the first end to a second diameter as it extends toward the second end, wherein the first diameter is larger than the second diameter. The opening further includes an internal surface threaded in direction opposite the threading of the threaded connecting device which must be removed. The device further includes structure for rotating the body when it is positioned over the threaded connecting device, wherein rotation of the body causes the internal threading of the removal device to engage the threaded connecting device causing the threaded connecting device to rotate in a direction appropriate for the removal of the threaded connecting device threaded in the first direction.

### SUMMARY OF THE INVENTION

In view of the foregoing disadvantages inherent in the known hand tool art, the present disclosure provides a novel screw removal means. The general purpose of the present disclosure, which will be described subsequently in greater detail, is to provide a screw removal tool.

A screw removal tool for removing damaged screws is disclosed herein, the screw removal tool comprising: a screw removal assembly that may include an extension shaft configured to be insertable into a universal screwdriver that may have a body configured to couple to and remove a damaged screw by engaging with a damaged screw via an internally toothed extraction fitment structured and arranged to grip the peripheral surface of a screw head in such a way that a grip-friction is impartable upon the screw head when the screwdriver is turned in a rotational direction about its linear axis.

According to another embodiment, a method of using a screw removal tool is also disclosed herein. The screw removal includes a first step; providing a screw removal tool for removal of a damaged screw, a screw removal assembly including a extension shaft configured to be insertable into a universal screwdriver for torquing use having a body configured to couple to and remove a damaged screw via engagement of the damaged screw with an internally toothed extraction fitment configured to engage a peripheral surface of a screw head of the damaged screw such that a grip-friction is impartable upon the screw head. The extension shaft is fixed to the body in functional combination, a second step; inserting the internally toothed extraction fitment into a universal screwdriver, a third step; placing internally toothed extraction fitment against damaged screw head, a fourth step; torquing screw removal assembly to remove damaged screw, a fifth step; removing damaged screw from the internally toothed extraction fitment, a sixth step; removing internally toothed extraction fitment from universal screwdriver, a seventh step; storing the internally toothed extraction fitment.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a screw removal tool, constructed and operative according to the teachings of the present disclosure.

FIG. 1 is a perspective view of the screw removal tool during an ‘in-use’ condition, according to an embodiment of the disclosure.

FIG. 2 is a perspective view of the screw removal tool of FIG. 1, according to an embodiment of the present disclosure.

FIG. 3 is a cross-sectional view of the screw removal tool, according to an embodiment of the present disclosure.

FIG. 4 is an end view of the screw removal tool, according to an embodiment of the present disclosure.

FIG. 5 is a flow diagram illustrating a method of use for a screw removal tool, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a hand tool and more particularly to a screw removal tool as used to improve the efficiency of removal of screws in a damaged condition.

Generally, the screw removal tool disclosed herein may be used to remove screws without the need for Phillips tip or slotted screw driver. It functions as an improved screw driver driven device with a head which grips around the head of a screw. It removes the screw by fitting around the head of the screw and engages the screw head with teeth so the user does not need a Phillips or a slotted tip screwdriver.

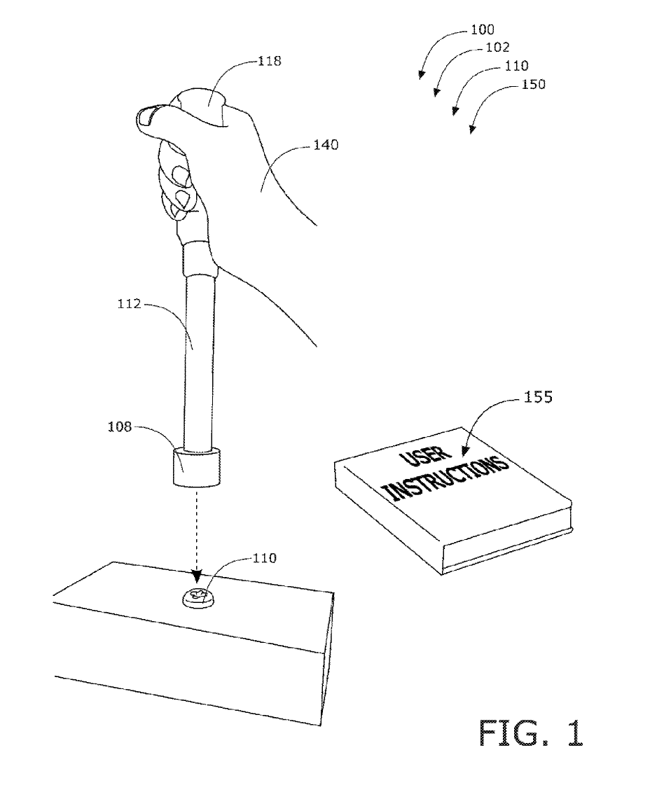

Referring now more specifically to the drawings by numerals of reference, there is shown in FIGS. 1-4, various views of a screw removal tool 100.

FIG. 1 shows a screw removal tool 100, during an ‘in-use’ condition 50, according to an embodiment of the present disclosure. Here, the screw removal tool 100 may be beneficial for use by a user 40 to remove damaged screws 106. As illustrated, the screw removal tool 100 may include a screw removal tool 100 for removing damaged screws 106; the screw removal tool 100 may provide a screw removal assembly 102 that can include an extension shaft 112 (that may be configured to be insertable into a universal screwdriver 104) for torquing use (may be used with another tool not comprising a driver as well) and a body 114 which can be configured to couple to and remove a damaged screw 106 via engagement of a damaged screw 106 with an internally toothed extraction fitment 108 configured to engage the peripheral surface of a screw head 110 of a damaged screw 106 such that a grip-friction is impartable upon the screw head 110. The extension shaft 112 may be fixed to the body 114 in functional combination. Upon reading this specification, it should be appreciated that, under appropriate circumstances, considering such issues as user preferences, design preference, structural requirements, marketing preferences, cost, available materials, technological advances, etc., other screw removal tool arrangements such as, for example, a one-piece screwdriver of different sizes, internal screw head gripping teeth, arrangements, etc., may be sufficient.

According to one embodiment, the screw removal tool 100 may be arranged as a kit 105. In particular, the screw removal tool 100 may further include a set of instructions 107. The instructions 107 may detail functional relationships in relation to the structure of the screw removal tool 100 such that the screw removal tool 100 can be used, maintained, or the like, in a preferred manner.

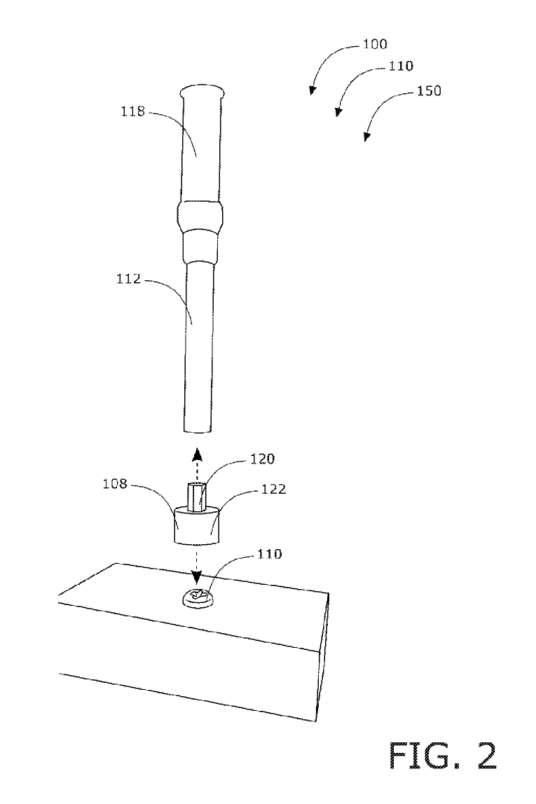

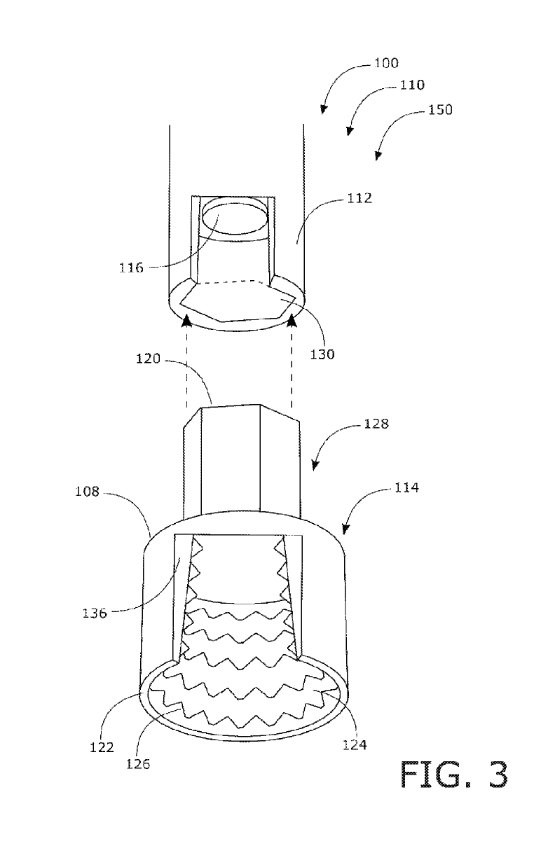

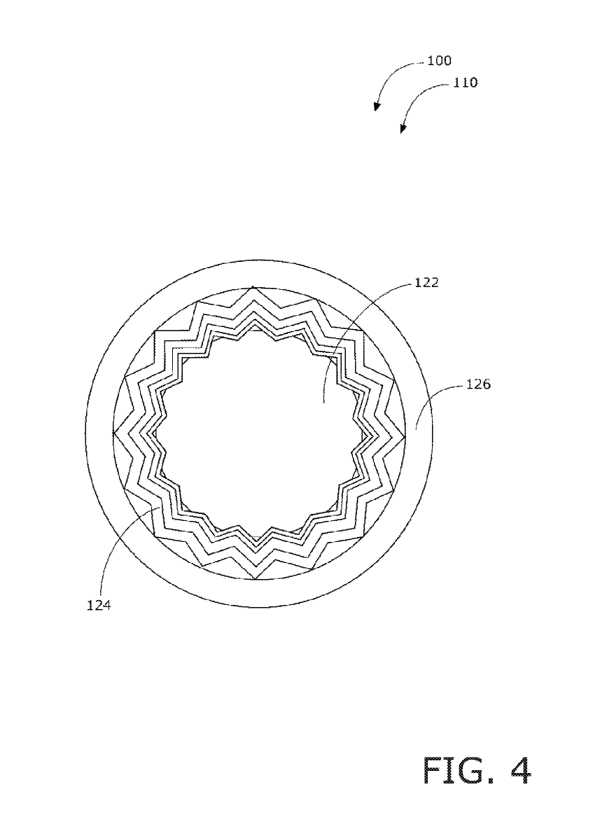

FIG. 2 shows the screw removal tool 100 of FIG. 1, according to an embodiment of the present disclosure. As above, the screw removal tool 100 may include a screw removal assembly 102 including: an extension shaft 112 which may be configured to be insertable into a universal screwdriver 104 for torquing use. The body 114 can be configured to couple to and remove a damaged screw 106, via engagement of the damaged screw 106 with an internally toothed extraction fitment 108 shown in more detail in FIGS. 3 and 4 configured to engage a peripheral surface of a screw head 110 of a damaged screw 106 such that a grip-friction is impartable upon the screw head 106. The extension shaft 112 may include an ergonomic hand grip 118 that may be affixed to the body 114 in functional combination.

The extension shaft 112 may be able to move in a ratcheting motion internally of the ergonomic hand grip 118 and the extension shaft 112 may have a magnetized fitment receiver 116 as shown in FIG. 3. The extension shaft 112 may further include a hexagonal interior 128 to receive an internally toothed extraction fitment 108 and may be constructed of a hardened material. Additionally the extension shaft engagement lug 120 and the internally toothed extraction fitment 108 of this embodiment are integral and may be of equal length.

FIG. 3 is a cross-sectional view of the screw removal tool 100 of FIG. 1, according to an embodiment of the present disclosure. In the preferred embodiment the extension shaft 112 may have a magnetized fitment receiver 116 and the internally toothed extraction fitment 108 may be constructed of a hardened alloy material and wherein the extension shaft 112 may include an ergonomic hand grip 118 as shown in FIG. 2.

As shown in this embodiment the internally toothed extraction fitment 108 may have an extension shaft engagement lug 120 at its proximal end and a screw engagement opening 122 at its distal end. The extension shaft engagement lug 120 can have a hexagonal exterior 128 configuration approximately ¼ inch in diameter extending approximately half a length of the body 114 and the magnetized fitment receiver 116 should have a hexagonal interior for receiving the extension shaft engagement lug 120 having a hexagonal exterior 128. Also shown in FIG. 3 the screw engagement opening 112 may be slightly larger at the distal end than at the proximal end and the internally toothed extraction fitment 108 may have a wall thickness 132 greater at the proximal end and slightly lesser at its distal end extending approximately half a length of the body 114.

FIG. 4 is an end view of the screw removal tool 100 of FIG. 1, according to an embodiment of the present disclosure. This figure shows the internal screw head gripping teeth 124 of the screw engagement opening 122 of the screw removal tool 100 and is representative of the preferred embodiment. The screw engagement opening 122 in this embodiment may include a series of internal screw head gripping teeth 124 and it should be noted that the internally toothed extraction fitment 108 can be constructed in various sizes and the internal screw head gripping teeth 124 in FIG. 4 are in vertical alignment with opening walls 126; however, in another embodiment the internal screw head gripping teeth 124 may be constructed in a vortexual alignment with opening walls 126.

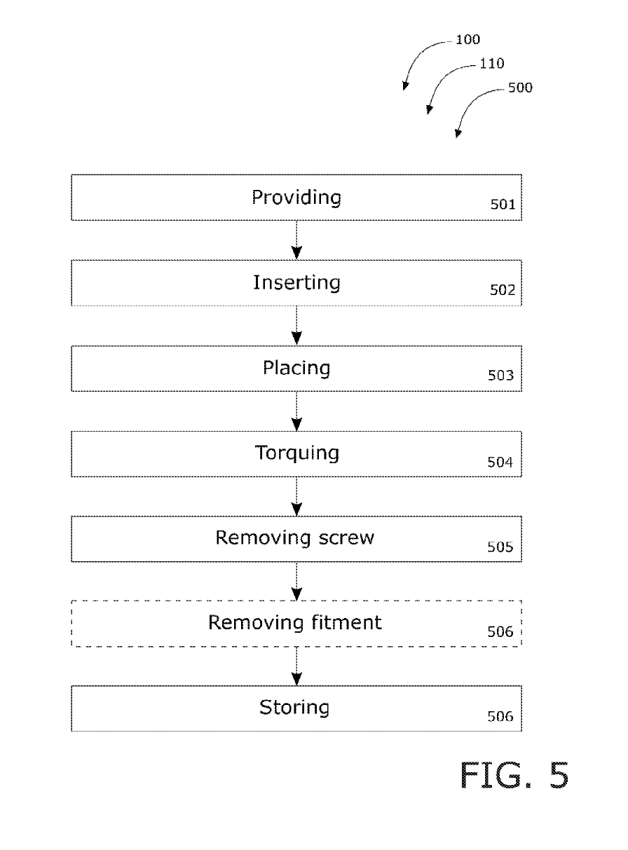

FIG. 5 is a flow diagram illustrating a method for using 500 a screw removal tool 100, according to an embodiment of the present disclosure. In particular, the method 500 for using the screw removal tool 100 may include one or more components or features of the screw removal tool 100 as described above. As illustrated, the method 500 for screw removal tool 100 may include the steps of: step one 501, providing a screw removal tool, for removal of a damaged screw; step two 502, inserting the internally toothed extraction fitment into a universal screwdriver; step three 503, placing internally toothed extraction fitment against damaged screw head; step four 504, torquing screw removal assembly to remove damaged screw; step five 505, removing damaged screw from internally toothed extraction fitment; step six 506, removing internally toothed extraction fitment from universal screwdriver; step seven 507, storing internally toothed extraction fitment.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods of use for the screw removal tool are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A screw removal tool for removing damaged screws, the screw removal tool comprising:
a screw removal assembly including;
a extension shaft configured to be insertable into a universal screwdriver for torquing use;
a body configured to couple to and remove a damaged screw via engagement of said damaged screw with an internally toothed extraction fitment configured to engage a peripheral surface of a screw head of said damaged screw such that a grip-friction is impartable upon said screw head; and
wherein said extension shaft is fixed to said body in functional combination.

2. The screw removal tool of claim 1, wherein the extension shaft is able to move in a ratcheting motion.

3. The screw removal tool of claim 1, wherein the extension shaft has a magnetized fitment receiver.

4. The screw removal tool of claim 3, wherein the magnetized fitment is constructed of a carbide material.

5. The screw removal tool of claim 1, wherein the extension shaft includes an ergonomic hand grip configuration.

6. The screw removal tool of claim 4, wherein the magnetized fitment has an extension shaft engagement lug at its proximal end.

7. The screw removal tool of claim 6, wherein the magnetized fitment has a screw engagement opening at its distal end.

8. The screw removal tool of claim 7, wherein the screw engagement opening includes a series of internal screw head gripping teeth.

9. The screw removal tool of claim 7, wherein the magnetized fitment is constructed in various sizes as a kit.

10. The screw removal tool of claim 8, wherein the internal screw head gripping teeth are in vertical alignment with opening walls.

11. The screw removal tool of claim 8, wherein the internal screw head gripping teeth are in a vortexual alignment with opening walls.

12. The screw removal tool of claim 6, wherein the engagement lug has a hexagonal exterior configuration approximately ¼ inch in diameter extending approximately half a length of the body.

13. The screw removal tool of claim 3, wherein the magnetized fitment receiver has a hexagonal interior.

14. The screw removal tool of claim 7, wherein the screw engagement opening is slightly larger at said distal end than at said proximal end.

15. The screw removal tool of claim 1, wherein the internally toothed extraction fitment has a wall thickness greater at the proximal end and slightly lesser at its distal end extending approximately half a length of the body.

16. The screw removal tool of claim 3, wherein the body includes an extension shaft engagement lug and said internally toothed extraction fitment and are integral and of equal length.

17. A screw removal tool, the device comprising:
a screw removal assembly including;
an extension shaft configured to be insertable into a universal screwdriver for torquing use;
a body configured to couple to and remove a damaged screw via engagement of said damaged screw with an internally toothed extraction fitment configured to engage a peripheral surface of a screw head of said damaged screw such that a grip-friction is impartable upon said screw head and an extension shaft that is fixed to said body in functional combination; and
wherein the extension shaft is able to move in a ratcheting motion and includes an ergonomic configuration and the extension shaft has a magnetized fitment receiver having a hexagonal interior to receive a fitment constructed of a carbide material.

18. The screw removal tool of claim 17, further comprising set of instructions; and
wherein the screw removal tool is arranged as a kit.

19. A screw removal tool, the method comprising the steps of:
providing a screw removal tool for removal of a damaged screw,
a screw removal assembly including,
an extension shaft configured to be insertable into a universal screwdriver for torquing use,
a body configured to couple to and remove a damaged screw via engagement of said damaged screw with an internally toothed extraction fitment configured to engage a peripheral surface of a screw head of said damaged screw such that a grip-friction is impartable upon said screw head, and
wherein said extension shaft is fixed to said body in functional combination,
inserting the internally toothed extraction fitment into the universal screwdriver,
placing the internally toothed extraction fitment against a damaged said screw head, and
torquing the screw removal assembly to remove a damaged screw.

20. The method of claim 19, further comprising the steps of;
removing the damaged screw from the internally toothed extraction fitment,
removing the internally toothed extraction fitment from the universal screwdriver, and
storing the internally toothed extraction fitment.
